(19) United States
(12) Patent Application Publication
(10) Pub. No.: US 2006/0176641 A1
(43) Pub. Date: Aug. 10, 2006

(54) Ionizing electrode structure and apparatus

(76) Inventors: Peter Gefter, So. South Francisco, CA (US); Scott Gehlke, Berkeley, CA (US); John K. O'Reilly, San Francisco, CA (US)

Correspondence Address: FENWICK & WEST LLP, SILICON VALLEY CENTER, 801 CALIFORNIA STREET, MOUNTAIN VIEW, CA, 94041, US

(21) Appl. No.: 11/353,760

(22) Filed: Feb. 13, 2006

Related U.S. Application Data
(63) Continuation-in-part of application No. 10/459,865, filed on Jun. 11, 2003.

(51) Int. Cl. H05F 3/04

(52) U.S. Cl. 361/213

(57) ABSTRACT

Ions for neutralizing electrostatic charge on an object are generated and delivered in a stream of gas flowing through a dielectric channel that surrounds a loop of conductive filament which forms an ionizing electrode. The loop is formed within a single plane, or within multiple planes, and is supported within the channel with a plane of the loop substantially aligned with flow of gas through the channel. A region of minimum field intensity within the bounded region of the loop electrode is oriented in alignment with substantially maximum velocity of gas flow through a cross section of the dielectric channel.

### RELATED APPLICATION

This application claims benefit under 35 U.S.C. § 120 as a continuation-in-part of application Ser. No. 10/459,865, filed on Jun. 11, 2003 by P. Gefter et al, which application is incorporated herein in the entirety by this reference thereto.

### FIELD OF THE INVENTION

This invention relates to air or gas ionizing electrodes and more particularly to apparatus for neutralizing electrostatic charge on an object by efficiently generating and collecting ions for delivery to the object in a flowing gas stream and in a low-maintenance manner.

### BACKGROUND OF THE INVENTION

Electrode structures for generating ions of one or other polarity commonly rely upon sharp pointed electrodes or small diameter stretched filaments for creating a corona discharge in response to an applied high ionizing voltage.

However, ions generated in this manner are strongly influenced by a high intensity electrical field near the electrode surface that controls ion movement and reduces the effectiveness of a flowing gas stream to capture, collect and deliver ions to the charged object.

Moreover, pointed electrodes and filament electrodes are prone to deposit on the electrode surfaces byproducts of corona discharge in the gas stream. These deposits of byproducts create instability of corona discharge, reduce ion generation and disrupt ion balance in the gas stream.

### SUMMARY OF THE INVENTION

In accordance with one embodiment of the present invention, a conductive filament is formed as a loop that is supported within a nozzle for a stream of flowing gas and that is connected to a source of high ionizing voltage.

The filament is formed from electrically conductive material, for example, such as tungsten or hastelloy alloy. The diameter of the filament ranges from about 10 to about 100 microns, and preferably is about 30-60 microns. The filament may have surface coating of corrosion-resistant materials in one or more layers that may be electrically conductive or non-conductive. For example, the surface coating may be glass or ceramic or metal or metal alloy.

The loop electrode may be formed in a flat two-dimensional or three-dimensional configuration and may have round or elliptical or semi-elliptical shape with various ratios of major and minor axes.

The loop electrode may be positioned in close proximity to a non-ionizing electrode and may be disposed in a flowing gas stream to move the generated ions and slow down the formation of corona byproducts. The gas may be an inert gas such as argon, or a low-moisture gas such as nitrogen or clean dry air (CDA).

Various configurations of the loop electrode, the support structure and the non-ionizing electrode are arranged to maximize interaction between generated ions and the flowing gas stream to enhance ions collection for delivery to a charged object.

In accordance with one embodiment of the present invention, two ionizing electrodes are each configured as a loop that is immersed in a flowing gas stream and is connected individually to one of positive and negative high voltage power supplies for optimized ion generation and ion collection. In accordance with one embodiment of the present invention the ionizing electrode is configured as a loop that is immersed in a flowing gas stream and is connected to AC high voltage power supply operating at a voltage and frequency that are preset to optimize ion generation and ion collection.

### BRIEF DESCRIPTION OF THE DRAWINGS

FIG. 1A is a plan view of one embodiment of the ionizing electrode according to the present invention in which a round loop is supported by a ceramic tube and is conductively connected to a high voltage terminal;

FIG. 1B is a plan view of one embodiment of the ionizing electrode according to the present invention in which an elliptical two-dimensional loop is supported by a ceramic tube and is conductively connected to a high voltage terminal;

FIG. 1C is a plan view of one embodiment of the ionizing electrode according to the present invention in which a semi-elliptical loop is supported by a conductive tube for connection to a high voltage terminal;

FIG. 2A is a pictorial view of a typical pattern of electrical field lines associated with a conventional pointed electrode positioned inside a dielectric tube;

FIG. 2B is a simplified graph of electrostatic field intensity distribution for the conventional pointed electrode of FIG. 2A;

FIG. 2C is a simplified graph of gas velocity distribution through a cross section of the dielectric tube of FIG. 2A;

FIG. 3A is a pictorial view of electrical field lines for one embodiment of the present invention in which the filament loop electrode is positioned inside a dielectric tube that confines gas flow therethrough;

FIG. 3B is a simplified graph of electrostatic field intensity distribution for the filament loop electrode positioned inside the dielectric tube in the embodiment of FIG. 3A;

FIG. 3C is a simplified graph of gas velocity distribution inside the dielectric tube of FIG. 3A;

FIG. 4A is a plan view illustrating different angular orientations of one embodiment of an ionizing electrode according to the present invention in which an elliptical three-dimensional loop electrode is supported by a glass bead for conductive connection to a high voltage terminal;

FIG. 4B is a plan view of one embodiment of the ionizing electrode according to the present invention in which an elliptical three-dimensional loop is supported on a conductive tube for connection to a high voltage terminal;

FIG. 5A is a sectional view of one embodiment of the ionizing electrode according to the present invention in which an elliptical two-dimensional loop electrode is positioned inside a dielectric tube and non-ionizing electrodes are positioned parallel to the plane of the loop electrode;

FIG. 5B is a sectional view of one embodiment of the ionizing electrode according to the present invention in which an elliptical two-dimensional loop electrode is positioned inside a dielectric tube and non-ionizing electrodes are positioned perpendicular to the plane of the loop electrode;

FIG. 6A is a sectional view of one embodiment of the ionizing electrode according to the present invention in which an elliptical flat loop electrode is positioned inside two concentric tubes and non-ionizing electrode are disposed parallel to the plane of the loop electrode;

FIG. 6B is a sectional view of one embodiment of the ionizing electrode according to the present invention in which a flat elliptical loop electrode is positioned inside two concentric tubes and non-ionizing electrodes are positioned perpendicular to the plane of the loop electrode;

FIG. 6C is a sectional view of one embodiment of the ionizing electrode according to the present invention in which a flat elliptical loop electrode is positioned inside two concentric tubes and in which the outer tube is a conductive, non-ionizing electrode;

FIG. 7A is a sectional view of one embodiment of the ionizing electrode according to the present invention in which a two-dimensional elliptical loop electrode is connected to receive AC ionizing voltage and is positioned inside a dielectric tube with non-ionizing electrodes positioned perpendicular to the loop electrode; and

FIG. 7B is a sectional view of one embodiment of apparatus according to the present invention in which an ionizing bar includes two elliptical two-dimensional loop electrodes positioned inside dielectric tubes and are connected separately to sources of positive and negative ionizing voltage.

### DETAILED DESCRIPTION OF THE INVENTION

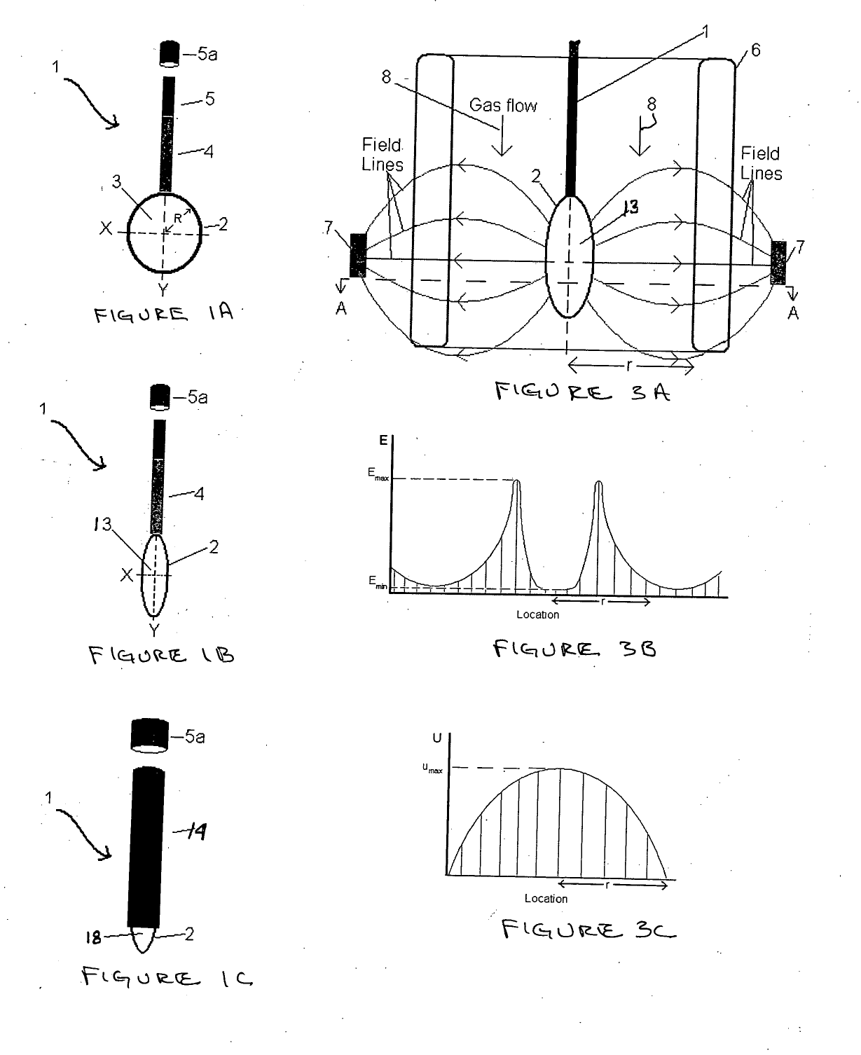

Referring now to FIG. 1A, there is shown a plan view of one embodiment of the present invention in which ionizing electrode 1 includes a conductive filament 2 in the form of a flat, round loop 3 having radius R. The loop radius may be in the range 0.1-50 mm, preferably, in the range 0.5-10 mm.

The loop 3 is supported by a dielectric structure, for example, ceramic tube 4 and is connected through a conductor in the dielectric structure to terminal 5 that forms an appropriate support and connection to socket 5a that is connected to a supply of high ionizing voltage.

Similarly, in the embodiment of FIG. 1B the filament 2 is formed as an elliptical two-dimensional loop lying within a plane. The elliptical configuration of the loop 13 is a suitable form for an ionizing electrode 1 positioned inside a confined space such as a tube or channel for confining a stream of flowing gas.

In the embodiment of FIG. 1C the filament 2 is configured as a semi-elliptical flat loop 18 as a suitable shape for an ionizing electrode 1 supported by a conductive structure 14 inside a confined space such as an outlet nozzle for release of gas under pressure above ambient.

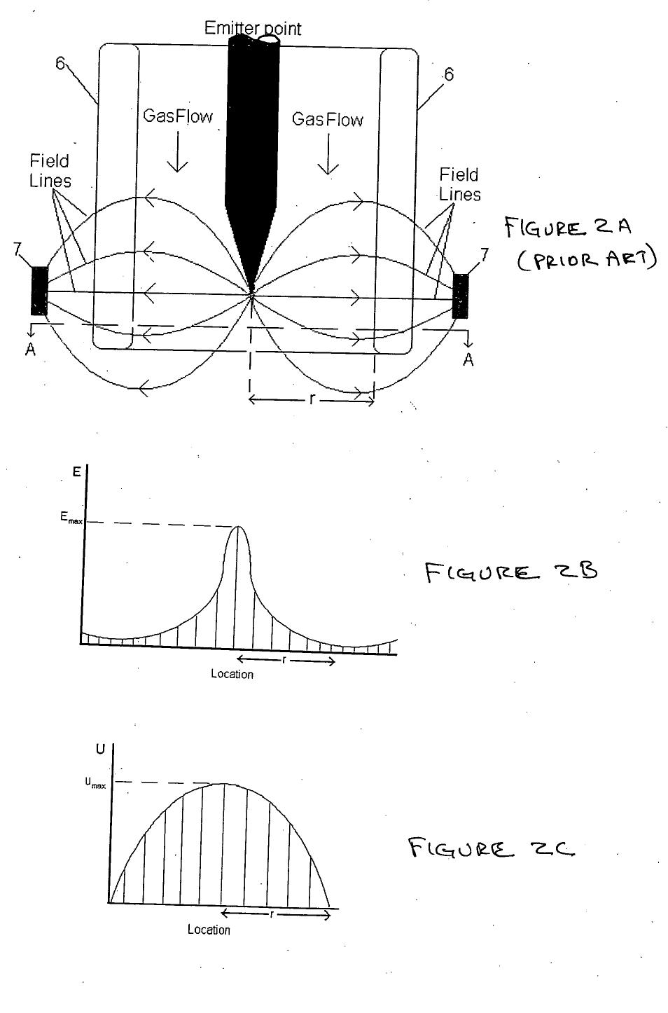

Referring to the pictorial view of FIG. 2A there is shown as conventional pointed ionizing electrode positioned inside a dielectric tube 6 of radius r that confines a flowing gas. Also shown is a simplified picture of electrostatic field lines distributed between the pointed electrode and the reference electrode 7.

Referring to FIG. 2B there is shown a plot of electrical field intensity E distribution in cross section A-A of FIG. 2A. High voltage applied to the pointed electrode creates maximum field intensity E max near the tip or point of the electrode that is positioned in the middle of dielectric tube 6 and that is surrounded by reference electrode 7. The tube confines a gas stream for moving ions away from the pointed electrode. As illustrated in FIG. 2C which is a plot of flowing gas velocity across the diameter of tube 6 at cross section A-A, the maximum of the field intensity E coincides with the maximum flowing gas velocity U max in the central region of the tube. Ion generation is concentrated in the small volume around the tip of the electrode and such generated ions are trapped in a strong electrical field around that location. These conditions promote inefficient collection and delivery of generated ions within the stream of flowing gas.

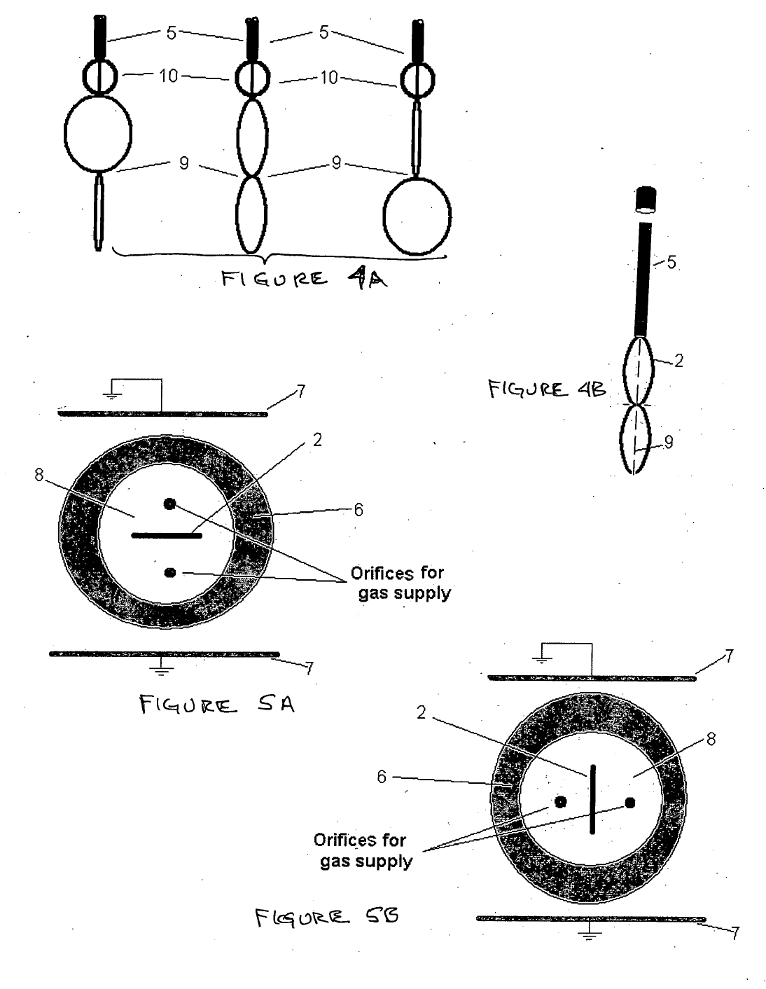

Referring now to FIG. 3A there is shown one embodiment of the present invention in which an elliptical loop 13 forming ionizing electrode 1 is positioned inside a dielectric tube 6 that confines a flowing gas stream 8. Also in FIG. 3B there is shown a simplified picture of electrostatic field lines between the filament loop electrode 13 inside the dielectric tube 6 and the non-ionizing electrode 7 disposed outside the dielectric tube 6.

According to Gauss's law, electric field intensity E is primarily concentrated about the outer dimensions of the loop conductor 2 (see FIG. 3A) operating at high voltage, as shown in the plot of FIG. 3B, with minimal electric field intensity Emin distributed within the bounds of the loop 13. As illustrated in FIG. 3C which is a plot of flowing gas velocity across the diameter of tube 6 at cross section A-A, the maximum gas velocity near the center of tube 6 coincides with location of minimum field intensity Emin. The near-maximum gas velocities about the center of tube 6 coincide with locations of maximum field intensities. Thus, ions generated about the looped filament conductor 2 are able to migrate toward the interior volume of loop 13 that exhibits low field intensity, and are maximally generated about the loop conductor 2, all in locations of maximum or near-maximum gas flow velocity within dielectric tube 6. These conditions promote highly efficient capture or collection and delivery of generated ions within the flowing gas stream (for example, toward a charged object to be neutralized, not shown).

The loop electrode embodiment of the present invention as illustrated in FIG. 3A thus effectively establishes large surface area for the generation and collection of ions within a stream of gas flowing past the loop electrode. Ions may diffuse or otherwise migrate toward the central region of low field intensity within the bounds of the loop electrode 2 for efficient collection and delivery within the central region of the gas stream that exhibits maximum flow velocity. And, the large emitting area of the loop electrode promotes lower current density per unit length along the loop conductor 2 with concomitant reduction in erosion of the conductor 2.

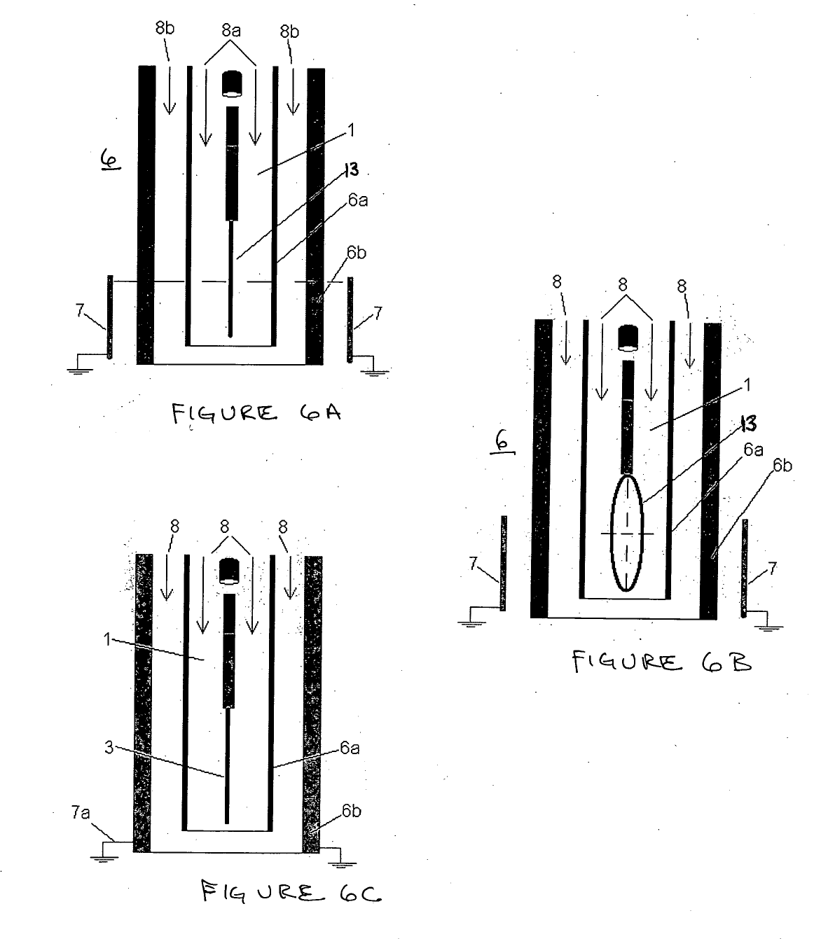

Referring now to FIG. 4A, there are shown separate angular orientations about a central axis of a looped filament electrode 9 that is configured as a three-dimensional loop with portions disposed in separate, skewed planes. This configuration exposes large surface areas of the loop filament 9 to a gas stream flowing past the conductor 9. The loop filament 9 is connected to a supporting electrical terminal 5 and is spaced therefrom by dielectric bead 10. Alternatively, as shown in FIG. 4B, the loop filament 9 may be directly attached to and supported by the conductive terminal 5 that also serves as a high voltage electrode.

Referring now to FIG. 5A there is shown a sectional view of one embodiment in which ionizing electrode 2 is configured as the elliptical, two-dimensional loop that is positioned within a dielectric tube 6 which confines a flowing stream of air or gas 8. Non-ionizing planar reference electrodes 7 are positioned outside the tube 6 and are oriented, for example, parallel to the plane of the loop electrode 2.

Ions generated by the loop ionizing electrode 2 are collected by flowing gas 8 passing through orifices 8 for delivery to a charged object (not shown). The gas 8 may be low-moisture dry clean air (CDA), nitrogen or a mix of gases for reducing formation of corona byproducts on the loop electrode 2.

Alternatively, as shown in the sectional view of FIG. 5B, the planar, non-ionizing reference electrodes 7 are positioned outside the tube 6 perpendicular to the plane of the loop electrode 2. Of course, the reference electrode 7 in each of the described embodiments may also be configured as a ring, or portions thereof, disposed about the outer periphery of dielectric tube 6.

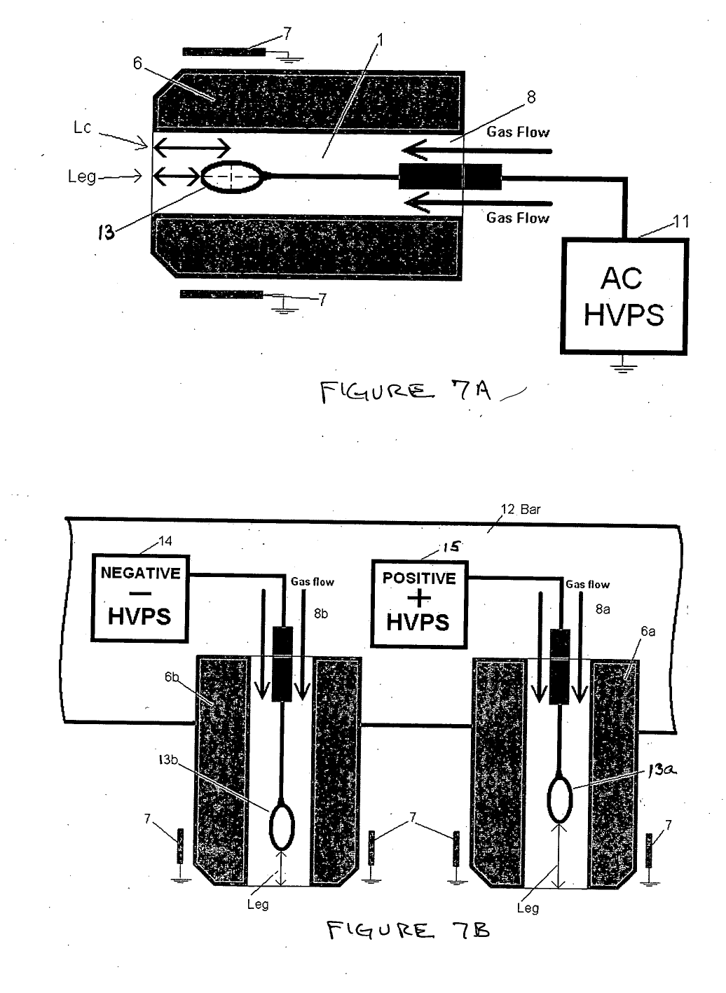

Referring now to FIG. 6A, there is shown a sectional view of one embodiment of the ionizing electrode 1 in which an elliptical flat loop electrode 13 is positioned inside a gas nozzle 6 comprising two concentric tubes 6a and 6b. A non-ionizing or reference electrode 7 is positioned parallel to the plane of the loop electrode 13. Gas 8 flowing in tube 6a may be different from gas flowing in tube 6b. For example, gas in tube 6a may be nitrogen 8a and gas flowing in tube 6b may be clean dry air 8b. Gas velocity and gas consumption in tube 6a and in tube 6b may be different. In this embodiment, the consumption of more expensive gas 8a may be minimized.

Alternatively, as shown in the sectional view of FIG. 6B, the ionizing loop electrode 13 is positioned inside the nozzle 6 and the non-ionizing electrode 7 is disposed perpendicular the plane of the loop electrode 13. Of course, the reference electrode 7 may also be configured as a ring, or portions thereof, disposed about the outer periphery of outer tube 6b.

Referring now to FIG. 6C, there is shown a sectional view of one embodiment of the ionizing electrode 1 in which the flat elliptical loop electrode 13 is positioned inside two concentric tubes 6a and 6b of different materials. The outer tube 6b is conductive and serves as a non-ionizing reference electrode 7a, and the inner tube 6a is formed of dielectric material.

Referring now to FIG. 7A there is shown a sectional view of one embodiment of the ionizing loop electrode in which the two-dimensional elliptical loop electrode 13 is connected to high AC ionizing voltage source 111 and is positioned inside dielectric tube 6 that confines a flowing gas 8. The planar non-ionizing electrode 7 is disposed outside the dielectric tube 6 perpendicular to the plane of the loop electrode 13. Of course, the reference electrode may be configured as a ring, or portions thereof, disposed about the outer periphery of tube 6.

The distal edge of the filament loop 13 is recessed L_{eg} relative to the orifice or distal end of the nozzle 6, or is recessed L_{c} between the center of the loop 13 and the orifice of the nozzle. The recess L_{eg} may be in the range (+)5-(−) 10 mm, preferably (+)1-(−)5 mm. “Positive recess” as used herein means that the distal edge of the loop 13 protrudes or is positioned outside the nozzle 6 and may be exposed to ambient air or gas. “Negative recess” as used herein means that the distal edge of the loop 13 is retracted or is positioned inside the nozzle 6.

Referring now to FIG. 7B there is shown a sectional view of one embodiment of ionizing electrodes according to the present invention assembled in apparatus such as an ionizing bar 12 comprising at least two elliptical loop electrodes 13a and 13b separately connected to positive and negative high voltage power supplies 14, 15, with each electrode positioned inside a dielectric nozzle 6a, 6b that confines a flowing gas 8a and 8b. The recesses L_{eg} of the loop electrodes 13a and 13b may be different. For example, the recess L_{eg} for negative-voltage electrode 13b may be smaller than the recess L_{eg} for positive-voltage loop electrode 13a. Also, the gas 8b flowing in the nozzle 6b may be different from gas 8a flowing in the nozzle 6a, or may flow at a different velocity. For example, the gas 8a may be clean dry air and gas 8b may be nitrogen. Generation of negative ions in nitrogen is more efficient with small recess L_{eg}. In this way, a desirable ion balance between generation of positive and negative ions can be achieved through combinations of two different recesses and compositions of two different gases flowing in the separate nozzles at different velocities.

Therefore, the ionizing electrodes of the present invention promote efficient generation of ions that can be readily captured in a stream of flowing gas for delivery to a charged object to be neutralized of static charge.

What is claimed is:

1. An ionizing electrode comprising:
a conductive filament configured as an elliptical loop; and
a support for the filament including a conductive connection thereto for applying high ionizing voltage.

2. An ionizing electrode as in claim 1 in which the loop is disposed substantially in a plane.

3. An ionizing electrode as in claim 1 in which segments of the loop are disposed in separate, skewed planes.

4. An ionizing electrode as in claim 1 in which the conductive filament has a cross-sectional dimension in the range between about 10 and 100 microns.

5. An ionizing electrode as in claim 4 in which the conductive filament has a cross-sectioned dimension in the range between about 30 and 60 microns.

6. An ionizing electrode as in claim 1 in which the conductive filament includes a surface coating.

7. An ionizing electrode as in claim 6 in which the surface coating includes a metal.

8. An ionizing electrode as in claim 6 in which the surface coating includes a dielectric material.

9. Ion-forming apparatus including an electrode of claim 1, and comprising:
a dielectric channel including walls surrounding the conductive filament for confining a stream of flowing gas about the filament.

10. Ion-forming apparatus as in claim 9 in which the stream of flowing gas includes at least one of clean dry air and nitrogen.

11. Apparatus according to claim 9 in which a major axis of the elliptical loop is substantially aligned with a flow of gas through the channel.

12. Apparatus according to claim 11 including a reference electrode spaced from the filament and disposed along a direction aligned with a minor axis of the loop.

13. Apparatus according to claim 1 including a reference electrode spaced from the filament and disposed along a direction substantially normal to major and minor axes of the loop.

14. Apparatus according to claim 11 including a reference electrode forming at least a portion of a conductive ring disposed adjacent the loop.

15. Apparatus according to claim 11 including a tubular element having walls disposed about the dielectric channel for confining a flow of gas through the tubular element, and for positioning a reference electrode thereabout.

16. Ion-forming apparatus comprising:
a conductive filament configured as a loop;
a dielectric channel surrounding the conductive filament for confirming a stream of flowing gas about the filament, a distal end of the dielectric channel forming an ortifice, and a distal extent of the loop filament being disposed at a selected position relative to the orifice.

17. Apparatus according to claim 16 in which the selected position is within a range of positive recess to negative recess relative to the orifice.

18. Apparatus to claim 17 in which the range includes not greater than 5 mm protrusion to not greater than 10 mm recess.

19. Apparatus according to claim 15 including a supply of a first gas under pressure communicating with at least one of the dielectric channel and tubular element for flowing a stream of the first gas therethrough.

20. Apparatus according to claim 19 including another supply of a second gas under pressure communicating with another of the dielectric channel and tubular element for flowing a stream of the second gas therethrough.

21. Apparatus according to claim 20 in which the flows of the first and second gases are at different rates; and,
at least one of gases is an inert gas.

22. Apparatus according to claim 16 in which a cross-sectional profile of a flow of gas through the dielectric channel includes a region of maximum velocity substantially centrally within the dielectric channel; and
the loop of conductive filament is supported within the dielectric channel with an axis of the loop substantially aligned with a flow of gas through the dielectric channel at a position substantially within said region of maximum velocity

23. Apparatus according to claim 22 in which the position of the loop of conductive filament orients an electric field of minimum intensity formed by the loop in response to high ionizing voltage applied thereto substantially in alignment with said region of maximum velocity of gas flow through the dielectric channel.

24. Apparatus according to claim 16 including a plural number of dielectric channels, each surrounding a conductive filament and each communicating with a supply of gas under pressure for flowing a stream of gas about the electrode; and
supplies of high ionizing voltages of one and opposite polarities connected to one and another of the electrodes supported within one and another of the plural number of dielectric channels.

25. Apparatus according to claim 24 in which each of the dielectric channels includes a distal end forming an orifice, and each of the loop electrodes including a distal extent positioned within a dielectric channel at a selected position therein relative to the associated orifice.

26. Apparatus according to claim 25 in which the distal extents of loop electrodes are positioned at different spacing relative to the associated orifices of one and another of the plural number of dielectric channels.

27. Apparatus according to claim 16 in which each of one and another of the plural number of dielectric channels communicates with a supply of a different gas under pressure; and
at least one loop electrode is connected to AC high voltage power supply operable at a selected voltage and frequency.

28. A method for delivering a stream of ions, comprising:
establishing a stream of a flowing gas having a cross-sectional profile of velocity across the stream;
positioning a loop of conductive filament within the stream with an axis of the loop oriented in substantial alignment with the stream of flowing gas; and
applying high ionizing voltage to the conductive filament.

29. The method according to claim 28 in which the loop of conductive filament is positioned to align a minimum of electric field intensity in response to voltage applied to the conductive filament substantially with a maximum velocity of gas flow through the dielectric channel.

30. The method according to claim 28 in which a dielectric channel surrounds the conductive filament to confine the stream of flowing thereabout; and
a distal extent of the conductive filament is selectively positioned relative to a distal end of the dielectric channel within a range of protrusion from, to recess within, the distal end of the dielectric channel.

31. The method according to claim 30 including a plurality of dielectric channels each including a loop of conductive filament therein, the method in which:
different gases flow through one and another of the plural number of dielectric channels; and
high ionizing voltages of one and opposite polarities are applied, respective to the conductive filaments within said one and said another of the plural number of dielectric channels.
